(19) United States
(12) Patent Application Publication
(10) Pub. No.: US 2026/0080034 A1
(43) Pub. Date: Mar. 19, 2026

(54) SQUARE ROOT CALCULATIONS ON AN ASSOCIATIVE PROCESSING UNIT

(71) Applicant: GSI Technology Inc., Sunnyvale, CA (US)

(72) Inventor: Eyal AMIEL, Rosh HaAyin (IL)

(21) Appl. No.: 19/328,162

(22) Filed: Sep. 14, 2025

Related U.S. Application Data
(60) Provisional application No. 63/696,394, filed on Sep. 19, 2024.

(51) Int. Cl. G06F 17/18; G06F 17/16

(52) U.S. Cl. CPC G06F 17/18; G06F 17/16

(57) ABSTRACT

A calculator for calculating a plurality of square roots includes a memory array, at least two registers, a bit subtractor, and a controller. The memory array is organized into columns and rows. The registers store a fixed value. The controller, operatively coupled to the other components, allocates a first set of rows to test variables and a second set to result variables, and initially stores each of a plurality of radicands in a separate column. For multiple iterations, the controller concurrently activates selections of rows to form current operands and current guesses for each column. The controller then instructs the bit subtractor to perform subtraction operations. For each column with a positive subtraction result, the controller selectively writes a new bit of the square root and selectively overwrites values with a new remainder derived from the subtraction result, without performing an explicit data-shifting operation.

### CROSS REFERENCE TO RELATED APPLICATIONS

This application claims priority from U.S. provisional patent application 63/696,394, filed Sep. 19, 2024, which is incorporated herein by reference.

### FIELD OF THE INVENTION

The present invention relates to calculations of square roots generally and to their digital calculation in particular.

### BACKGROUND OF THE INVENTION

Digital methods for calculating the square root of a binary number, or radicand, are known in the art. A common approach involves an iterative procedure of guessing and testing to determine the bits of the square root result, typically starting from the most significant bit (MSB). In each iteration, a new bit of the result is guessed, a new temporary result is formed, and the square of this temporary result is compared to the original radicand to determine if the guess was correct. While functional, such methods can be computationally intensive.

An improved method for calculating the square root of a number X is disclosed in U.S. Pat. No. 12,106,071, commonly owned by Applicant and incorporated herein by reference. This method operates iteratively, bit by bit, using two primary variables, typically referred to as a PREV variable and a CHECK variable. The PREV variable initially stores the radicand X and is subsequently updated to store the remainder from the previous subtraction operation. The CHECK variable is built up during the iterative process to form the value that is subtracted from the PREV variable in each step.

For each iteration i, a ‘1’ is placed at the “squared” location of the current bit bᵢ (i.e. the location which is twice the current location of bᵢ) within the CHECK variable. This CHECK variable is then subtracted from the PREV variable. The value of the bit bᵢ is determined to be ‘1’ if the result of this subtraction is positive, and ‘0’ if it is negative.

To correctly position the bits for the subsequent subtraction, the method shifts all previously determined bits within the CHECK variable one position to the right. After this shift operation, the newly determined value of bit bᵢ is then added into its own squared location within the now-shifted CHECK variable. This process of subtracting, determining, shifting, and adding is repeated for all bits of the square root.

While the method of U.S. Pat. No. 12,106,071 provides an efficient calculation, it still fundamentally relies on an explicit data-shifting operation in every iteration. The requirement to physically shift all previously found bits within the CHECK variable, along with the subtraction operation on a potentially large number of bits, contributes to the computational load and latency of the overall process.

### SUMMARY OF THE PRESENT INVENTION

There is therefore provided, in accordance with a preferred embodiment of the present invention, a method of operating an associative processing unit (APU) for concurrently calculating a plurality of square roots for a plurality of radicands. The APU includes a memory array organized into a plurality of columns and rows. The method includes allocating a first set of rows to test variables and a second set of rows to result variables, initially storing each radicand in a separate one of the plurality of columns in the first set of rows, and for each of a plurality of iterations, performing concurrently: activating, based on a test pointer, a selection of rows from the first set of rows to form current operands, activating, based on a result pointer, a selection of rows from the second set of rows and the two registers to form current guesses, performing subtraction operations involving the current operands and the current guesses to produce subtraction results. For each of the plurality of columns yielding a positive subtraction result, the method also includes selectively writing a new bit of the square roots to a target row within the second set of rows of the columns, and selectively overwriting values in the selection of rows from the first set of rows of the columns with new remainders derived from the subtraction results.

Moreover, in accordance with a preferred embodiment of the present invention, the method further includes, for each of the plurality of columns yielding a negative or zero subtraction result, maintaining a default value for the new bit of the square roots and maintaining existing values in the selection of rows from the first set of rows.

Further, in accordance with a preferred embodiment of the present invention, the selection of rows from the first set of rows includes two rows for a first iteration of the plurality of iterations, four rows for a second iteration, and i+2 rows for each subsequent iteration i, where i is greater than two.

Still further, in accordance with a preferred embodiment of the present invention, for the first and a second iteration, the test pointer indicates a row corresponding to a most significant bit of the test variables, where for each subsequent iteration, the method includes shifting the test pointer to indicate a next adjacent row.

Additionally, in accordance with a preferred embodiment of the present invention, for a second iteration, the result pointer indicates a row corresponding to a most significant bit of the result variables, and where for each subsequent iteration, the method includes shifting the result pointer to indicate a next adjacent row in the second set of rows.

Moreover, in accordance with a preferred embodiment of the present invention, the two registers include a first register storing a ‘0’ and a second register storing a ‘1’, and the method includes forming the current guesses by appending the value ‘01’ to previously determined bits of the square roots.

Further, in accordance with a preferred embodiment of the present invention, the method further includes, upon completion of the plurality of iterations, outputting, for each of the plurality of columns, the square roots from the result variables and a final remainder from the test variables.

There is therefore provided, in accordance with a preferred embodiment of the present invention, a calculator operative on an associative processing unit (APU) for calculating a plurality of square roots for a plurality of radicands. The calculator includes a memory array, at least two registers, a bit subtractor, and a controller. The memory array is organized into a plurality of columns and rows. The at least two registers store a fixed value. The controller, operatively coupled to the memory array, the at least two registers, and the bit subtractor, allocates a first set of rows within the memory array to test variables and a second set of rows to result variables, and initially stores each of the plurality of radicands in a separate one of the plurality of columns in the first set of rows. For each of a plurality of iterations, the controller performs concurrently for each of the plurality of columns: activating, based on a test pointer, a selection of rows from the first set of rows to form current operands, activating, based on a result pointer, a selection of rows from the second set of rows and the at least two registers to form current guesses, and instructing the bit subtractor to perform subtraction operations involving the current operands and the current guesses to produce subtraction results. For each of the plurality of columns yielding a positive subtraction result, the controller selectively writes a new bit of the square roots to a target row within the second set of rows of the columns, and selectively overwrites values in the selection of rows from the first set of rows of the columns with new remainders derived from the subtraction results.

Still further, in accordance with a preferred embodiment of the present invention, the selection of rows from the first set of rows includes two rows for a first iteration of the plurality of iterations, four rows for a second iteration, and i+2 rows for each subsequent iteration i, where i is greater than two.

Additionally, in accordance with a preferred embodiment of the present invention, for the first and a second iteration, the test pointer indicates a row corresponding to a most significant bit of the test variables, where for each subsequent iteration, the controller shifts the test pointer to indicate a next adjacent row.

Moreover, in accordance with a preferred embodiment of the present invention, for a second iteration, the result pointer indicates a row corresponding to a most significant bit of the result variables, and where for each subsequent iteration, the controller shifts the result pointer to indicate a next adjacent row in the second set of rows.

Further, in accordance with a preferred embodiment of the present invention, the two registers include a first register storing a ‘0’ and a second register storing a ‘1’, and the controller forms the current guesses by appending the value ‘01’ to previously determined bits of the square roots.

There is also provided, in accordance with a preferred embodiment of the present invention, a method of operating an associative processing unit (APU) for calculating a square root of a radicand, the APU including a memory array organized into a plurality of columns and rows. The method includes allocating a first set of rows to a test variable and a second set of rows to a result variable, initially storing the radicand in a column in the first set of rows, and for each of a plurality of iterations: activating, based on a test pointer, a selection of rows from the first set of rows to form a current operand, activating, based on a result pointer, a selection of rows from the second set of rows and two registers storing a fixed value to form a current guess, performing subtraction operations involving the current operand and the current guess to produce a subtraction result, and if the subtraction result is positive: selectively writing a new bit of the square root to a target row within the second set of rows, and selectively overwriting values in the selection of rows from the first set of rows with a new remainder derived from the subtraction result.

There is also provided, in accordance with a preferred embodiment of the present invention, a calculator operative on an associative processing unit (APU) for calculating a square root of a radicand. The calculator includes a memory array, at least two registers, a bit subtractor, and a controller. The memory array is organized into a plurality of columns and rows. The at least two registers store a fixed value. The controller, operatively coupled to the memory array, the at least two registers, and the bit subtractor, allocates a first set of rows within the memory array to a test variable and a second set of rows to a result variable, and initially stores the radicand in a column in the first set of rows. For each of a plurality of iterations, the controller activates, based on a test pointer, a selection of rows from the first set of rows to form a current operand, activates, based on a result pointer, a selection of rows from the second set of rows and the at least two registers to form a current guess, and instructs the bit subtractor to perform subtraction operations involving the current operand and the current guess to produce a subtraction result. If the subtraction result is positive, the controller selectively writes a new bit of a square root to a target row within the second set of rows, and selectively overwrites values in the selection of rows from the first set of rows of the columns with a new remainder derived from the subtraction result.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A, 1B, 1C, 1D and 1E are textual illustrations showing the iterative steps of a bit-wise binary square root calculation;

FIG. 2 is a schematic illustration of a prior art associative processing unit;

FIG. 3 is a schematic block diagram illustration of a square root calculator, constructed and operative according to an embodiment of the present invention;

FIG. 4 is a schematic block diagram illustration showing a bit subtractor component forming part of the calculator of FIG. 3;

FIGS. 5A and 5B are schematic illustrations depicting a sequence of bitwise subtraction operations performed by the calculator of FIG. 3 in a first iteration;

FIGS. 6A, 6B, 6C and 6D are schematic illustrations showing the state of variables within the square root calculator of FIG. 3 during subsequent iterations; and

FIG. 7 is a flow chart illustration of the method implemented by the calculator of FIG. 3.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that the square root calculation method can be significantly optimized for implementation on an associative processing unit (APU), which stores data in columns within an associative memory array and performs bit-wise computations within those columns.

Applicant has also realized that a bit-wise binary method for the square root calculation, which is similar to manual long division, may be particularly suited for an efficient, shift-less implementation on an Associative Processing Unit (APU). The bit-wise binary method operates on pairs of bits from the radicand, rather than on individual digits, and each iterative guess may be formed by appending the value 01 to the previously determined portion of the result.

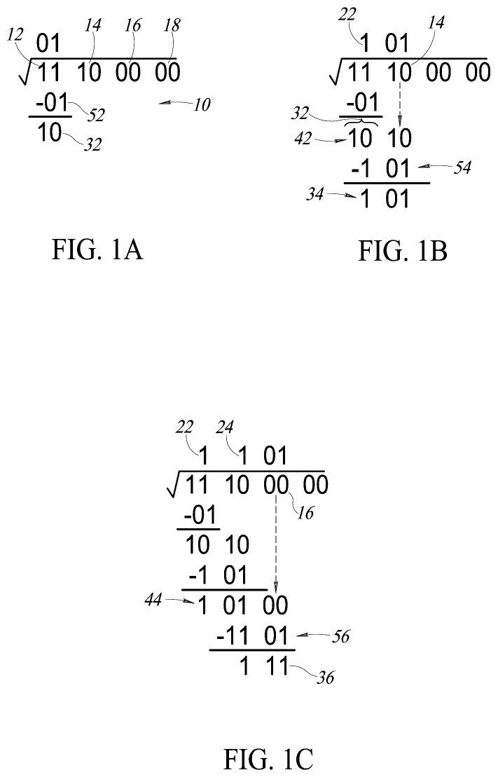

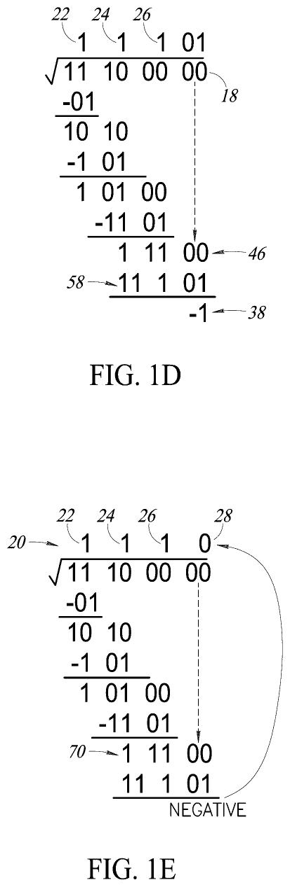

Reference is now made to FIGS. 1A-1E, which collectively illustrate a prior art bit-wise binary calculation method. The process operates on a radicand 10, which in this example is the 8-bit binary value 11100000, which has the integer value of 224. In this method, the radicand 10 is processed as a series of bit-pairs: a first bit-pair 12 (11), a second bit-pair 14 (10), a third bit-pair 16 (00), and a fourth bit-pair 18 (00).

In the first iteration, shown in FIG. 1A, a first guess 52, having a value of 01, is initially both placed at the most significant bit (MSB) location and also subtracted from first bit-pair 12 to produce a first remainder 32 of 10. Since first remainder 32 is positive, a first result bit 22 (in FIG. 1B) of a square root result is 1.

For the second iteration, second bit-pair 14 is brought down and appended to first remainder 32, forming a first operand 42 with a value of 1010. A second guess 54 is formed by appending guess value 01 to the current square root result of 1, creating the value 101. Second guess 54 is subtracted from first operand 42, producing a second remainder 34 of 101. Since second remainder 34 is positive, a second result bit 24 (FIG. 1C) is set to 1.

For the third iteration, illustrated in FIG. 1C, third bit-pair 16 (00) is brought down and appended to second remainder 34, forming a second operand 44 with a value of 10100. Similarly, a third guess 56 of 1101 is formed by appending 01 to the current square root result of 11. Third guess 56 is subtracted from second operand 44, producing a third remainder 36 of 111. Because this result is also positive, a third result bit 26 (FIG. 1D) is set to 1.

For the fourth and final iteration, illustrated in FIG. 1D, fourth bit-pair 18 is brought down and appended to third remainder 36, forming a third operand 46 with a value of 11100. A fourth guess 58 of 11101 is formed by appending 01 to the current square root result of 111. Fourth guess 58 is subtracted from third operand 46, producing a fourth remainder 38 (−1) with a negative value. Because the result is negative, a fourth result bit 28 (FIG. 1E) is set to 0. The calculation may then conclude, yielding a final square root result 20 of 1110 and a final remainder 70 equal to the value of third operand 46.

Applicant has realized that the calculation of FIG. 1A-1E may be easily implemented in an APU with bit-wise computations within its columns. Specifically, Applicant has realized that in such a bit-line processing environment, where a controller activates individual memory rows and columns (effectively acting as a pointer to any bit), the explicit SHIFT operation required of the prior art is entirely unnecessary. Instead of physically shifting data to align operands for a subtraction, the controller may dynamically select the appropriate, possibly non-contiguous bits from their static locations in the memory array and may provide them to a bit-subtractor in the correct logical order.

Furthermore, Applicant has realized that because the operations are performed bit-by-bit, there is no need to handle or process the entire N-bit variable in each iteration. The subtraction operation can be confined to only the currently active bits: namely, the bits of the most recent remainder and the bits forming the current guess. This guess is formed by the controller virtually concatenating the already-found bits of the square root with the value “01” by activating the corresponding memory cells.

Consequently, Applicant has realized that by eliminating the data-shifting step and performing targeted, bit-wise subtractions orchestrated by a controller, the computational complexity and latency of each iteration can be substantially reduced. The result is a more efficient method that is uniquely suited to the parallel, in-memory computing architecture of an APU.

An exemplary APU may be the Gemini APU, commercially available from GSI Technology Inc of the USA, and particularly, the Gemini 2 (G2) APU.

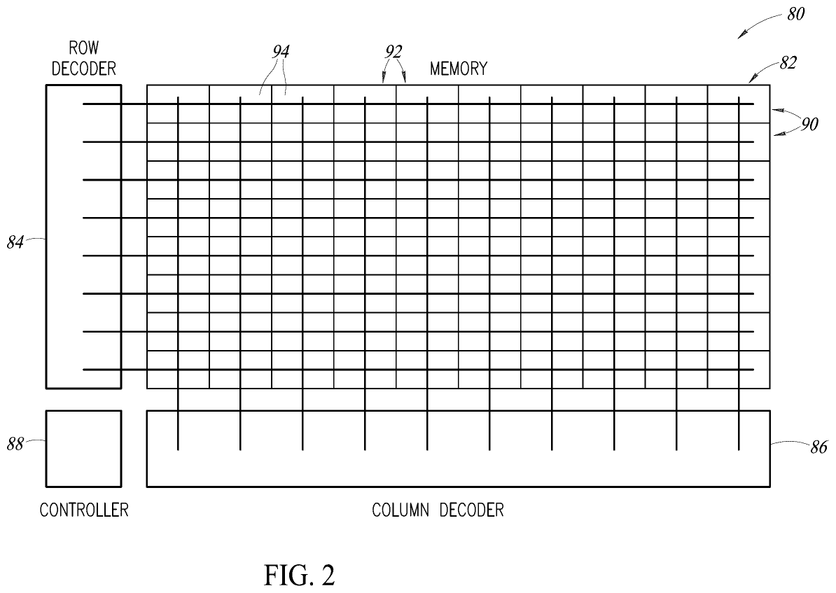

Reference is now made to FIG. 2, which illustrates an exemplary associative processing unit (APU) 80. In one embodiment, APU 80 comprises an associative memory array 82, a row decoder 84, a column decoder 86, and a controller 88.

Associative memory array 82 may comprise a plurality of memory cells 94 arranged in a grid of rows 90 and columns 92. Each column 92 may store a number to be operated upon. A word line may connect the cells 94 in each row 90, and a bit line processor may connect the cells 94 in each column 92 to perform computations on the data within that column.

Controller 88 may perform operations one bit at a time by controlling row decoder 84 and column decoder 86. Row decoder 84 may activate one or more rows 90 concurrently via their respective word lines. Similarly, column decoder 86 may activate one or more columns 92 concurrently. By activating multiple columns 92 simultaneously, controller 88 may enable the concurrent computation of the same bit across multiple numbers stored in different columns, which facilitates the efficient parallel execution of operations such as the bit-wise square root calculation.

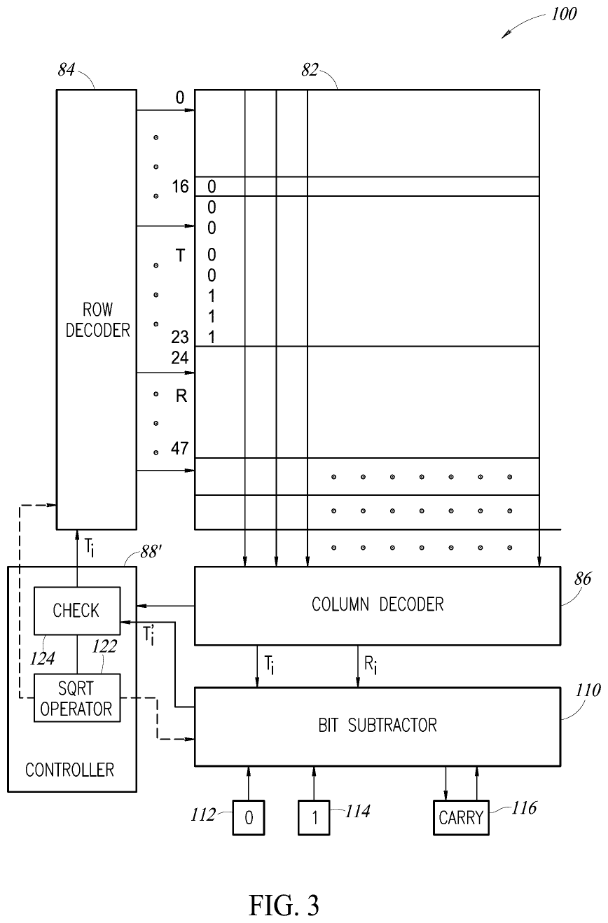

Reference is now made to FIG. 3, which illustrates an exemplary square root calculator 100, in accordance with an embodiment of the invention. Calculator 100 may be implemented on APU 80 (FIG. 2) with its associative memory array 82, row decoder 84, column decoder 86, and controller, here labelled 88′, together with a bit subtractor 110, a fixed zero register 112, a fixed one register 114, and a carry register 116.

In this embodiment, associative memory array 82 may perform one square root calculation per column and in each active column may store data of a separate test variable T, which initially may store the N-bit radicand value X, and a separate result variable R, which may store the bits of the square root result as they are determined. In the embodiment of FIGS. 3, 8-bit test variable T is shown as the example value of 11100000 (integer value of 224) from FIG. 1 and is stored in bits 16-23 of the first column of memory array 82. The 4 bit result variable R will be written into bits 44-47 of the same column.

Bit subtractor 110 may perform single-bit subtractions and may operate with changeable carry register 116 for storing a current carry, or borrow, value per column. Fixed zero register 112 may store a logic value of ‘0’ and fixed one register 114 may store a logic value of ‘1’, useful for providing the initial guess for the square root calculations.

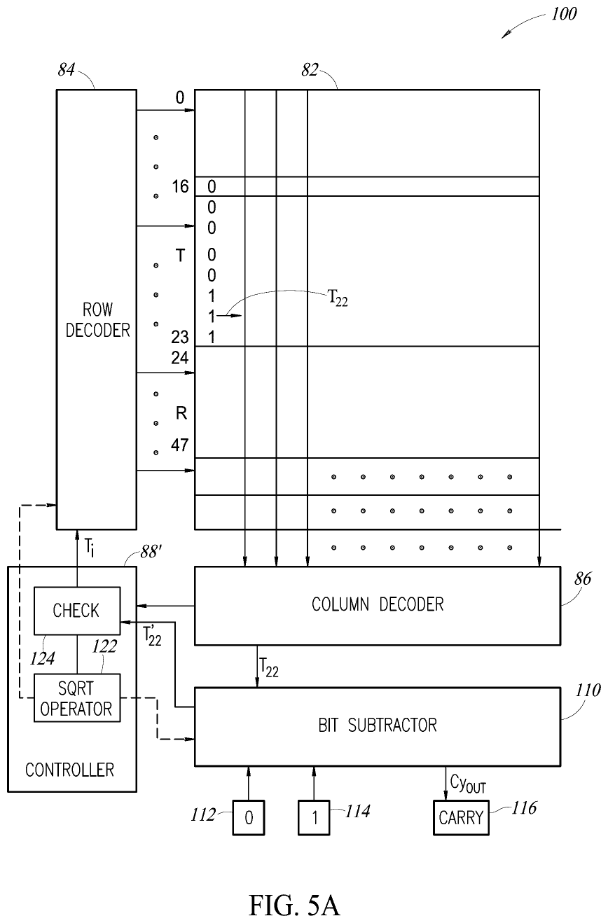

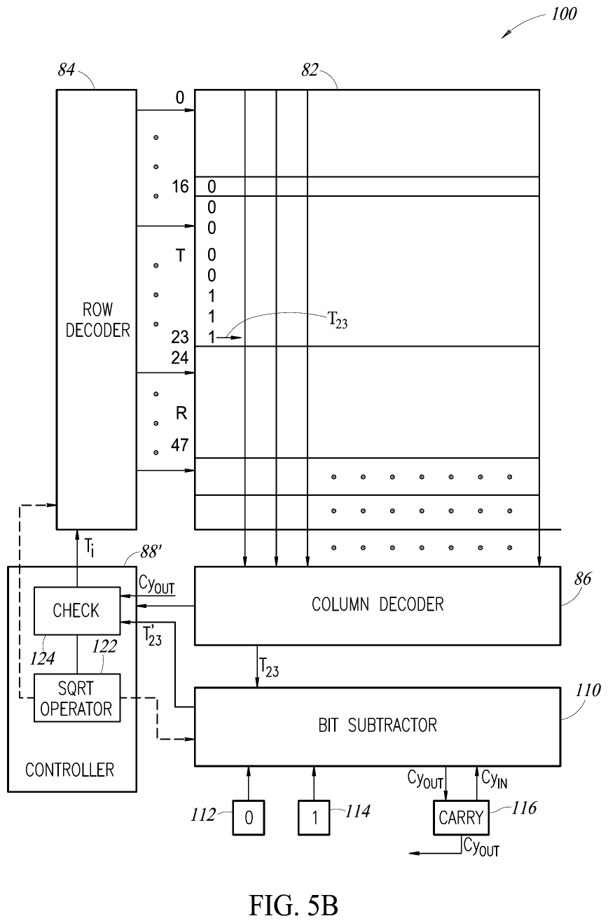

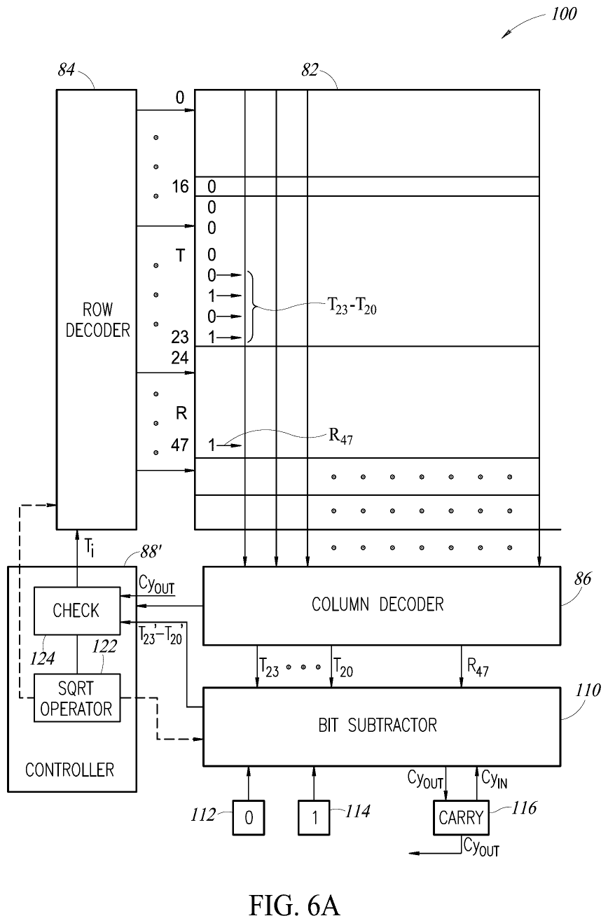

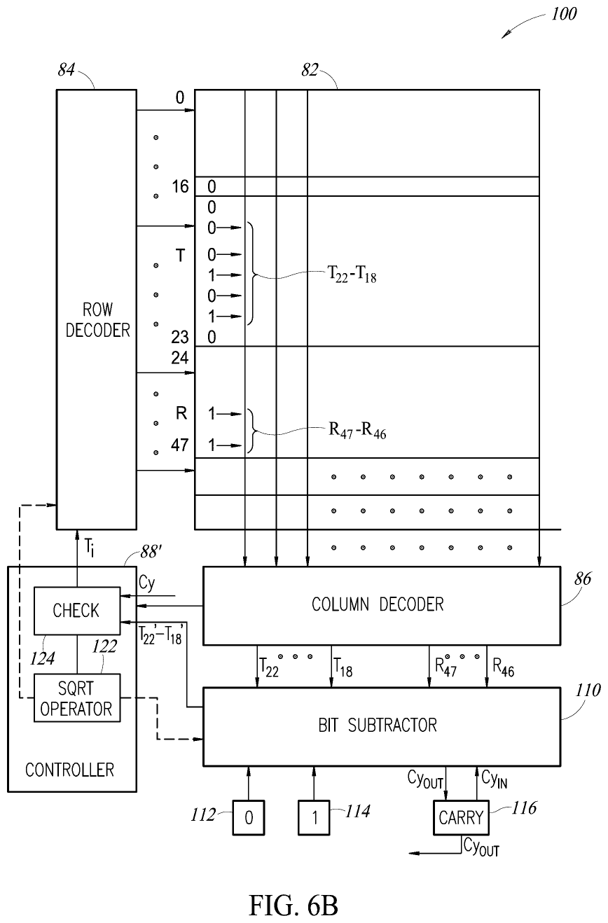

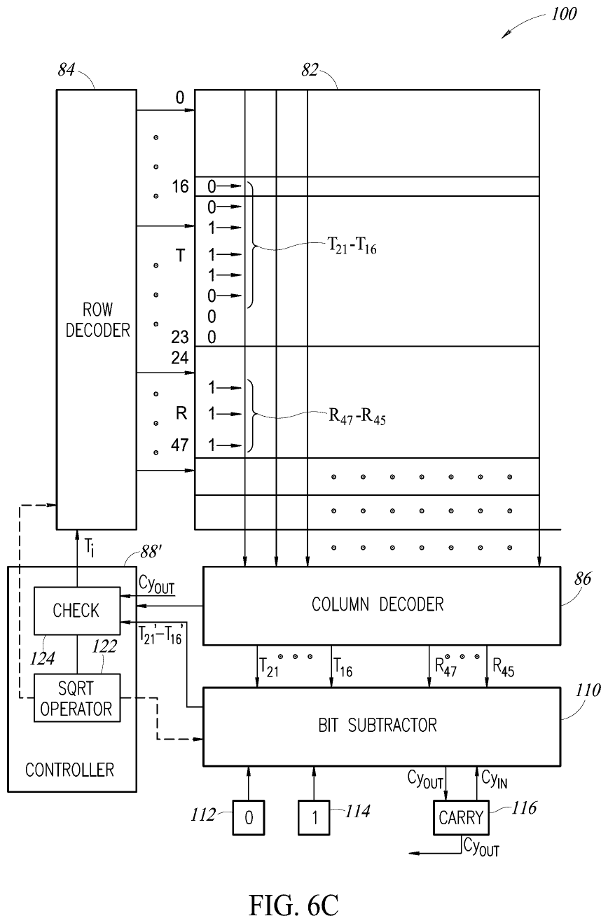

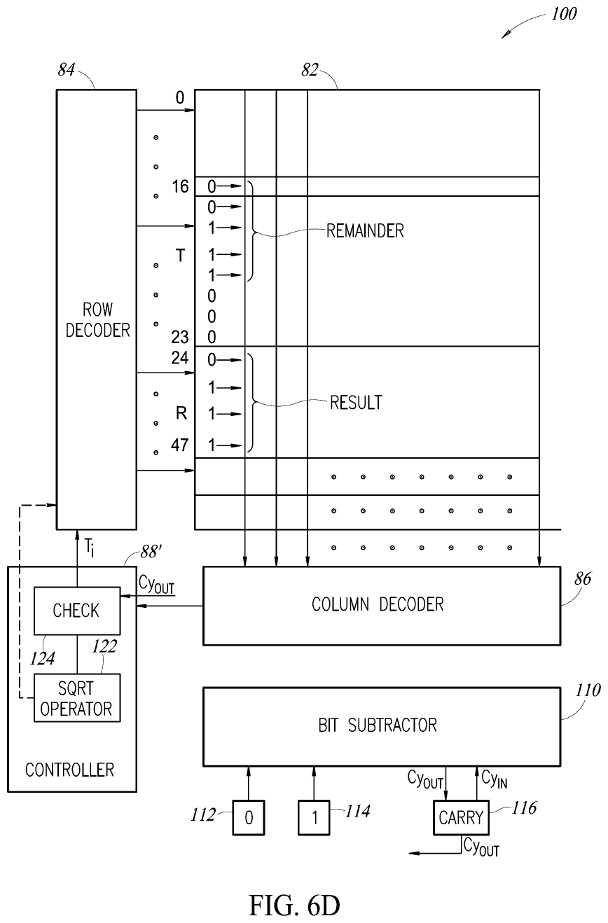

Controller 88′ may comprise a square root operator 122 and a check unit 124. Square root operator 122 may activate row decoder 84 and column decoder 86 to perform the iterative square root operations, as described hereinbelow with respect to FIGS. 5A, 5B, 6A, 6B, 6C and 6D. Check unit 116 may determine if the result of a subtraction operation performed by subtraction unit 110 is positive or negative, and, accordingly, may determine the value of the next bit of the square root result, to be stored in result variable R.

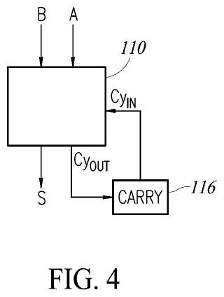

Reference is now made to FIG. 4, which details bit subtractor 110, in accordance with an embodiment of the invention. Bit subtractor 110 may operate in conjunction with square root operator 122, carry register 116, and check unit 124 to perform bitwise subtraction operations.

Square root operator 122 may activate the rows of memory cells 84 storing a first bit A and a second bit B and may activate their relevant columns in order to provide bits A and B of the columns to the inputs of bit subtractor 110 (where bits B and A may be the relevant bits of test variable T and result variable R, respectively). Square root operator 122 may also activate carry register 116 to provide a per-column, carry-in value Cyᵢₙ. In the context of subtraction, the per-column, carry-in value Cyᵢₙ may represent a borrow from a previous, less significant bit, operation for that column. Bit subtractor 110 may perform a per-column, single-bit subtraction operation, of B-A+Cyᵢₙ, to produce a subtraction result S and a carry out Cyₒᵤₜ, or a borrow value for each active column, based on an internal truth table for subtraction.

Square root operator 122 may write per-column, subtraction results S to the relevant bit locations of test variables T within memory array 82, thereby overwriting the previous values of that bit. Square root operator 122 may also write the per-column, carry out Cyₒᵤₜ into carry register 116. Stored per-column, carry out Cyₒᵤₜ may then be used as the per-column, carry-in value Cyᵢₙ for a subsequent bitwise subtraction operation. Furthermore, square root operator 122 may provide per-column, carry out Cyₒᵤₜ to check unit 124, which may use these values to determine if the overall subtraction operation for an iteration resulted in a per-column, positive or negative value.

For each iteration i, check unit 124 may perform the following:
For those columns whose borrow (i.e. Cyₒᵤₜ) is 0, then the difference was positive, so the value of the result R in those columns becomes 1. Check unit 124 may activate row decoder 84 to write a 1 in the row of those columns storing the relevant bit of result R. For those columns whose borrow is 1, then the difference was negative, so the value of the relevant bit of result R remains 0 since result variable R was initially set to 0, check unit 124 does not do anything to change the values of the relevant bit of the result R.

Reference is now made to FIGS. 5A and 5B, which illustrate how bit subtractor 110 may perform a multi-bit subtraction through a sequence of single-bit operations. Each iteration of the square root calculation may require more than one such bitwise subtraction, with the number of operations being a function of the number of bits involved in the current subtraction. For clarity, the discussion below describes a single column operation. It will be appreciated that multiple operations may be performed in parallel on values in separate columns.

In the first iteration, only two bits of the test variable T are involved, namely T₂₃ and T₂₂. FIG. 5A illustrates a first bitwise subtraction operation where square root operator 122 may activate row 22, to provide bit T₂₂ to the bit line processor of the column and may activate fixed one register 114 to provide a 1 value. Bit subtractor 110 may receive these values and may output a difference S (i.e. the updated value for T₂₂, shown as T₂₂′) and a borrow value (i.e. Cyₒᵤₜ) to carry register 116.

FIG. 5B illustrates a second bitwise subtraction operation where square root operator 122 may activate row 23 to provide bit T₂₃ and may activate fixed zero register 112 to provide a 0 value. Bit subtractor 110 may also use the carry from the previous operation stored in carry register 116. Through this sequence, square root calculator 100 may effectively subtract the 2-bit value 01 from the most significant bit-pair (11) of test variable T, leaving a difference of 10.

Square root operator 122 may activate check unit 124 on the result, which, since the result is positive, may generate a 1 and square root operator 122 may write the 1 as the first bit of the square root into result variable R, at its most significant bit (MSB) location (i.e. bit 47).

At the same time, square root operator 122 may activate the relevant rows of test variable T to write the bits of the difference (i.e. 10) back into the relevant cells of test variable T (i.e. into rows 23 and 22, for bits T₂₃ and T₂₂), as shown in FIG. 6A.

Reference is now made to FIGS. 6A-6D, which illustrate the subsequent iterations of the square root calculation. For clarity, the individual bitwise subtraction operations are not shown, but rather the overall subtraction for each iteration is discussed.

FIG. 6A illustrates the second iteration. Square root operator 122 may activate the four rows corresponding to bits T₂₃-T₂₀, which store the remainder from the first iteration (10) and the next bit-pair (10), forming the operand 1010. Square root operator 122 may also activate the row for bit R₄₇, which stores the first bit of the result (1), as well as the fixed zero and fixed one registers 112 and 114, respectively, to form the guess 101. Bit subtractor 110 may activate carry unit 116 as necessary to subtract 101 from 1010, leaving a positive remainder of 101. Check unit 124 may determine that the result is positive, and square root operator 122 may write a 1 into bit R₄₆ of result variable R. Concurrently, square root operator 122 may activate the cells for bits T₂₃-T₂₀ to write the remainder 0101 as bits T₂₃′-T₂₀′ back into test variable T.

FIG. 6B illustrates the third iteration. Square root operator 122 may activate the rows for the bits storing the previous remainder (101) and the next bit-pair (00) (i.e. rows T₂₂-T₁₈), forming the operand 10100. It may also activate the rows for result bits R₄₇ and R₄₆, and the fixed registers 112 and 114, to form the guess 1101. The subtraction yields a positive remainder of 111. Accordingly, square root operator 122 may write a 1 into bit R₄₅ of result variable R and may write the remainder 0111 into the relevant cells of test variable T.

FIG. 6C illustrates the fourth iteration. Square root operator 122 may activate the rows storing the previous remainder (0111) and the next bit-pair (00) (i.e. the rows storing test bits T21-T16) to form the operand 011100. It may activate the rows for result bits R₄₇, R₄₆, and R₄₅, along with fixed registers 112 and 114, to form the guess 11101. The subtraction yields a negative result. Since the result is negative, check unit 124 may determine that the fourth bit of the square root is 0, and the value in bit R₄₄ remains at its default state of 0.

FIG. 6D illustrates the final state of the variables. As this is the last pair, square root operator 122 may output the values. The final result, read from result variable R in bits R₄₇-R₄₄, is 1110. The final remainder, read from the active bits of test variable T, is 11100.

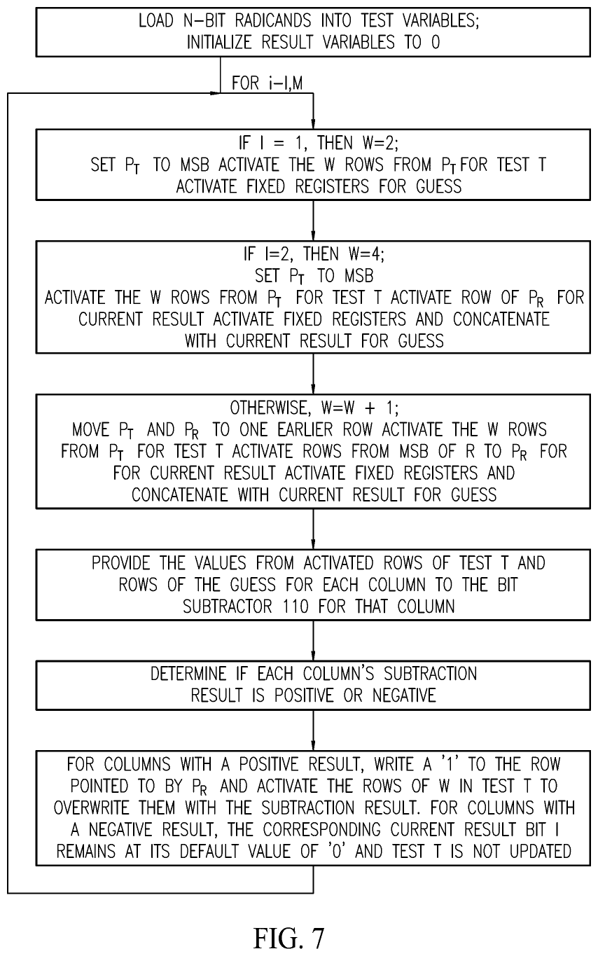

Reference is now made to FIG. 7, which illustrates the method performed by square root operator 122, for concurrently calculating an M-bit square root for each of a plurality of N-bit radicands stored in respective columns of memory array 82. N may be any of any length, such as 8, as in the example hereinabove, 16, 32, 64 or longer. Since the bits are binary, M is half of N (i.e. N=2M).

Initially, square root operator 122 may load each N-bit radicand into its column, in the section for test variables T, and may initialize the M bits of result variable R for each column to default values of zero. It will be appreciated that the method described hereinbelow is the same for all sizes of operands; all that changes is which rows of the columns hold test variable T and which rows hold result variable R.

Square root operator 122 may then perform M iterations, indexed by a counter i from 1 to M, to determine each bit of the square root result. The following steps may be performed concurrently for each active column during each iteration i.

Square root operator 122 may have two pointers, a test pointer P_{T} and a result pointer P_{R}, indicating the data to use in each iteration. Square root operator 122 may form the current operand for each column by activating a predetermined set of rows within that column's test variable T, where the bits in the set of rows comprise a remainder from a previous iteration and a next unprocessed bit-pair of the radicand, as described hereinbelow.

The size of an active window W of bits, which begins at the row indicated by test pointer P_{T}, is a direct function of the iteration number. For an M-bit square root, the number of rows activated for the operand in iteration i (where i ranges from 1 to M) may be i+2 for iterations 3 and above. For iteration 1, window W is 2 and for iteration 2, window W is 4. This window encompasses the bits holding the remainder from the previous iteration and the next unprocessed bit-pair of the original radicand.

For iterations 1 and 2, test pointer P_{T} may point to the MSB (T₂₃ in the example of FIG. 6). Thus, square root operator 122 may activate 2 or 4 rows, respectively from test pointer P_{T}. For iterations 3 on, square root operator 122 may shift test pointer P_{T} by one earlier row. Thus, for iteration 3, square root operator 122 may shift test pointer P_{T} to row T₂₂ and may activate 5 rows, and for iteration 4, square root operator 122 may shift test pointer P_{T} to row T₂₁ and may activate 6 rows.

Concurrently, square root operator 122 may dynamically form the current guess value for each column. This second set of activated rows comprises the rows of the previously determined bits in that column's result variable R, beginning at the row storing the MSB of result variable R (row R₄₇ in the example of FIG. 6), along with a bit from fixed zero register 112 and a bit from fixed one register 114. At each iteration, square root operator may use result pointer P_{R} to indicate the last row of result variable R for this iteration. For iteration 1, there are not yet any result bits. For iteration 2, result pointer P_{R} points to the MSB row. For each following iteration, result pointer P_{R} is decreased by 1, moving to an earlier row.

The values from the activated rows for the operand and the guess for each column may be provided in the correct logical order to the bit subtractor 110 for that column. Each bit subtractor 110 may then concurrently perform a multi-bit subtraction. The check unit 124 for each column may then concurrently determine if its respective subtraction result is positive or negative.

The subsequent write operations may then be performed based on these determinations. For those columns yielding a positive result, square root operator 122 may write a ‘1’ in the row corresponding to the current result bit i in their respective result variable R. Square root operator 122 may also activate the rows of the active window in their test variable T to write therein the new remainder value (i.e. the subtraction result). For those columns yielding a negative result, their corresponding current result bit i remains at its default value of ‘0’, and the remainder in their test variable T is not updated.

Upon completion of all M iterations, square root operator 122 may output, for each respective column, the final M-bit values from result variable R as the square root value and the final value from the active window of test variable T as the remainder.

It will be appreciated that the method and system described herein eliminate the explicit data-shifting operation in prior art methods. Instead, square root operator 122 may dynamically select the appropriate bits from their locations in memory array 82. By replacing the shift operation with dynamic bit selection, the computational complexity and latency of each iteration may be substantially reduced.

Consequently, the guess for each iteration may be formed by square root operator 122 activating the memory cells of the already-found bits of the square root, stored in result R, with the value ‘01’, stored in fixed registers 112 and 114, and providing their values in the correct logical order to bit subtractor 110, without any data movement within result variable R.

A further advantage arises from the column-based architecture of the APU. Multiple square root operations may be performed concurrently, with each calculation taking place in its own column on a different radicand. This enables a high degree of parallelism, significantly increasing throughput for applications requiring numerous square root calculations.

Furthermore, because the operations are performed bit-by-bit and are orchestrated by square root operator 122, only the currently active bits need to be processed and rewritten to the test variable in each iteration. This targeted approach avoids handling the entire N-bit variable in every step, further enhancing the efficiency of the calculation.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of operating an associative processing unit (APU) for concurrently calculating a plurality of square roots for a plurality of radicands, said APU comprising a memory array organized into a plurality of columns and rows, the method comprising:
allocating a first set of rows to test variables and a second set of rows to result variables;
initially storing each radicand in a separate one of said plurality of columns in said first set of rows;
for each of a plurality of iterations, performing concurrently:
activating, based on a test pointer, a selection of rows from said first set of rows to form current operands;
activating, based on a result pointer, a selection of rows from said second set of rows and said two registers to form current guesses;
performing subtraction operations involving said current operands and said current guesses to produce subtraction results; and
for each of said plurality of columns yielding a positive subtraction result:
selectively writing a new bit of said square roots to a target row within said second set of rows of said columns; and
selectively overwriting values in said selection of rows from said first set of rows of said columns with new remainders derived from said subtraction results.

2. The method of claim 1, further comprising, for each of said plurality of columns yielding a negative or zero subtraction result, maintaining a default value for said new bit of said square roots and maintaining existing values in said selection of rows from said first set of rows.

3. The method of claim 1, wherein said selection of rows from said first set of rows comprises two rows for a first iteration of said plurality of iterations, four rows for a second iteration, and i+2 rows for each subsequent iteration i, where i is greater than two.

4. The method of claim 1, wherein for said first and a second iteration, said test pointer indicates a row corresponding to a most significant bit of said test variables, wherein for each subsequent iteration, the method comprises shifting said test pointer to indicate a next adjacent row.

5. The method of claim 1, wherein for a second iteration, said result pointer indicates a row corresponding to a most significant bit of said result variables, and wherein for each subsequent iteration, the method comprises shifting said result pointer to indicate a next adjacent row in said second set of rows.

6. The method of claim 1, wherein said two registers comprise a first register storing a ‘0’ and a second register storing a ‘1’, and wherein the method comprises forming said current guesses by appending the value ‘01’ to previously determined bits of said square roots.

7. The method of claim 1, further comprising, upon completion of said plurality of iterations, outputting, for each of said plurality of columns, said square roots from said result variables and a final remainder from said test variables.

8. A calculator operative on an associative processing unit (APU) for calculating a plurality of square roots for a plurality of radicands, said calculator comprising:
a memory array organized into a plurality of columns and rows;
at least two registers configured to store a fixed value;
a bit subtractor; and
a controller operatively coupled to said memory array, said at least two registers, and said bit subtractor, said controller configured to:
allocate a first set of rows within said memory array to test variables and a second set of rows to result variables;
initially store each of said plurality of radicands in a separate one of said plurality of columns in said first set of rows; and
for each of a plurality of iterations, perform concurrently for each of said plurality of columns:
activating, based on a test pointer, a selection of rows from said first set of rows to form current operands;
activating, based on a result pointer, a selection of rows from said second set of rows and said at least two registers to form current guesses;
instructing said bit subtractor to perform subtraction operations involving said current operands and said current guesses to produce subtraction results; and
for each of said plurality of columns yielding a positive subtraction result:
selectively writing a new bit of said square roots to a target row within said second set of rows of said columns; and
selectively overwriting values in said selection of rows from said first set of rows of said columns with new remainders derived from said subtraction results.

9. The calculator of claim 8, wherein said selection of rows from said first set of rows comprises two rows for a first iteration of said plurality of iterations, four rows for a second iteration, and i+2 rows for each subsequent iteration i, where i is greater than two.

10. The calculator of claim 8, wherein for said first and a second iteration, said test pointer indicates a row corresponding to a most significant bit of said test variables, wherein for each subsequent iteration, said controller is configured to shift said test pointer to indicate a next adjacent row.

11. The calculator of claim 8, wherein for a second iteration, said result pointer indicates a row corresponding to a most significant bit of said result variables, and wherein for each subsequent iteration, said controller is configured to shift said result pointer to indicate a next adjacent row in said second set of rows.

12. The calculator of claim 8, wherein said two registers comprise a first register storing a ‘0’ and a second register storing a ‘1’, and wherein said controller is configured to form said current guesses by appending the value ‘01’ to previously determined bits of said square roots.

13. A method of operating an associative processing unit (APU) for calculating a square root of a radicand, said APU comprising a memory array organized into a plurality of columns and rows, the method comprising:
allocating a first set of rows to a test variable and a second set of rows to a result variable;
initially storing said radicand in a column in said first set of rows;
for each of a plurality of iterations:
activating, based on a test pointer, a selection of rows from said first set of rows to form a current operand;
activating, based on a result pointer, a selection of rows from said second set of rows and two registers storing a fixed value to form a current guess;
performing subtraction operations involving said current operand and said current guess to produce a subtraction result; and
if said subtraction result is positive:
selectively writing a new bit of said square root to a target row within said second set of rows; and
selectively overwriting values in said selection of rows from said first set of rows with a new remainder derived from said subtraction result.

14. A calculator operative on an associative processing unit (APU) for calculating a square root of a radicand, said calculator comprising:
a memory array organized into a plurality of columns and rows;
at least two registers configured to store a fixed value;
a bit subtractor; and
a controller operatively coupled to said memory array, said at least two registers, and said bit subtractor, said controller configured to:
allocate a first set of rows within said memory array to a test variable and a second set of rows to a result variable;
initially store said radicand in a column in said first set of rows; and
for each of a plurality of iterations:
activating, based on a test pointer, a selection of rows from said first set of rows to form a current operand;
activating, based on a result pointer, a selection of rows from said second set of rows and said at least two registers to form a current guess;
instructing said bit subtractor to perform subtraction operations involving said current operand and said current guess to produce a subtraction result; and
if said subtraction result is positive:
selectively writing a new bit of a square root to a target row within said second set of rows; and
selectively overwriting values in said selection of rows from said first set of rows of said columns with a new remainder derived from said subtraction result.
